(19) United States
(12) Patent Application Publication
(10) Pub. No.: US 2026/0238756 A1
(43) Pub. Date: Aug. 13, 2026

(54) Signalling Improvement For In-loop Filtering In Video Coding

(71) Applicant: Bytedance Inc., Los Angeles, CA (US)

(72) Inventors: Yue LI, San Diego, CA (US); Kai ZHANG, San Diego, CA (US); Li ZHANG, San Diego, CA (US)

(21) Appl. No.: 19/633,448

(22) Filed: Mar. 30, 2026

Related U.S. Application Data
(63) Continuation of application No. PCT/US2024/048798, filed on Sep. 27, 2024.
(60) Provisional application No. 63/586,717, filed on Sep. 29, 2023.

(51) Int. Cl. H04N 19/103; H04N 19/70

(52) U.S. Cl. CPC H04N 19/103; H04N 19/70

(57) ABSTRACT

A mechanism for processing video data is disclosed. The mechanism determines to use only a slice-level filtering mode to indicate whether a block-level parameter selection is used. That is, a residual scaling flag is not used to indicate whether the block-level parameter selection is used. A conversion is performed between a visual media data and a bitstream based on the slice-level filtering mode.

### CROSS-REFERENCE TO RELATED APPLICATIONS

This patent application is a continuation of International Patent Application PCT/US2024/048798, filed on Sep. 27, 2024, which claims the priority to and the benefit of U.S. Provisional Patent Application No. 63/586,717 filed on Sep. 29, 2023. All the aforementioned patent applications are hereby incorporated by reference in their entireties.

### TECHNICAL FIELD

The present disclosure relates to processing of digital images and video.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data in a neural network comprising: determining to use only a slice-level filtering mode to indicate whether a block-level parameter selection is used; and performing a conversion between visual media data and a bitstream based on the slice-level filtering mode.

Optionally, in any of the preceding aspects, another implementation of the aspect provides that a residual scaling flag is not used to indicate whether the block-level parameter selection is used.

Optionally, in any of the preceding aspects, another implementation of the aspect provides that the residual scaling flag has N+2 states, where N of the states are used to indicate using an i\hat{ }th (i=1, . . . , N) fixed scaling factor.

Optionally, in any of the preceding aspects, another implementation of the aspect provides that a remaining two of the states are used to indicate not using residual scaling and using a derived scaling factor.

Optionally, in any of the preceding aspects, another implementation of the aspect provides that the residual scaling flag is binarized with a fixed length code, a unary code, a truncated unary code, an Exponential-Golomb code, a K-th Exponential-Golomb code where K=0, or a truncated Exponential-Golomb code.

Optionally, in any of the preceding aspects, another implementation of the aspect provides determining to apply a high operation point (HOP) filter.

Optionally, in any of the preceding aspects, another implementation of the aspect provides determining to apply a low operation point (LOP) filter.

Optionally, in any of the preceding aspects, another implementation of the aspect provides that a slice header of the bitstream includes a slice neural network loop filter hop mode plus one (slice_nnlf_hop_mode_plus1) syntax element when a sequence parameter set neural network loop filter hop enabled flag (sps_nnlf_hop_enabled_flag) syntax element is true.

Optionally, in any of the preceding aspects, another implementation of the aspect provides that the slice header includes a slice neural network loop filter hop scale flag plus one (slice_nnlf_hop_scale_flag_plus1) syntax element when the slice neural network loop filter hop mode plus one (slice_nnlf_hop_mode_plus1) syntax element is not equal to zero.

Optionally, in any of the preceding aspects, another implementation of the aspect provides determining whether the slice neural network loop filter hop mode plus one (slice_nnlf_hop_mode_plus1) syntax element is less than a sequence parameter set neural network loop filter hop maximum number of parameters (sps_nnlf_hop_max_num_prms) syntax element plus one when the slice neural network loop filter hop scale flag plus one (slice_nnlf_hop_scale_flag_plus1) syntax element is equal to one.

Optionally, in any of the preceding aspects, another implementation of the aspect provides setting a slice neural network loop filter hop scale luminance (slice_nnlf_hop_scale_y) syntax element equal to the slice neural network loop filter hop mode plus one (slice_nnlf_hop_mode_plus1) syntax element minus one when the slice neural network loop filter hop mode plus one (slice_nnlf_hop_mode_plus1) syntax element is less than a sequence parameter set neural network loop filter hop maximum number of parameters (sps_nnlf_hop_max_num_prms) syntax element plus one.

Optionally, in any of the preceding aspects, another implementation of the aspect provides setting a slice neural network loop filter hop scale blue difference chroma (slice_nnlf_hop_scale_cb) syntax element equal to the slice neural network loop filter hop mode plus one (slice_nnlf_hop_mode_plus1) syntax element minus one when the slice neural network loop filter hop mode plus one (slice_nnlf_hop_mode_plus1) syntax element is less than a sequence parameter set neural network loop filter hop maximum number of parameters (sps_nnlf_hop_max_num_prms) syntax element plus one.

Optionally, in any of the preceding aspects, another implementation of the aspect provides setting a slice neural network loop filter hop scale red difference chroma (slice_nnlf_hop_scale_cr) syntax element equal to the slice neural network loop filter hop mode plus one (slice_nnlf_hop_mode_plus1) syntax element minus one when the slice neural network loop filter hop mode plus one (slice_nnlf_hop_mode_plus1) syntax element is less than a sequence parameter set neural network loop filter hop maximum number of parameters (sps_nnlf_hop_max_num_prms) syntax element plus one.

Optionally, in any of the preceding aspects, another implementation of the aspect provides initially setting a parameter identifier (prmId) syntax element to zero, determining whether the parameter identifier (prmId) syntax element is less than the sequence parameter set neural network loop filter hop maximum number of parameters (sps_nnlf_hop_max_num_prms) syntax element, and incrementing the parameter identifier (prmId) syntax element until the parameter identifier (prmId) syntax element is not less than the sequence parameter set neural network loop filter hop maximum number of parameters (sps_nnlf_hop_max_num_prms) syntax element when the slice neural network loop filter hop mode plus one (slice_nnlf_hop_mode_plus1) syntax element is not less than a sequence parameter set neural network loop filter hop maximum number of parameters (sps_nnlf_hop_max_num_prms) syntax element plus one.

Optionally, in any of the preceding aspects, another implementation of the aspect provides setting the slice neural network loop filter hop scale luminance (slice_nnlf_hop_scale_y) syntax element equal to the parameter identifier (prmId) syntax element when the parameter identifier (prmId) syntax element is not less than the sequence parameter set neural network loop filter hop maximum number of parameters (sps_nnlf_hop_max_num_prms) syntax element.

Optionally, in any of the preceding aspects, another implementation of the aspect provides setting the slice neural network loop filter hop scale blue difference chroma (slice_nnlf_hop_scale_cb) syntax element equal to the parameter identifier (prmId) syntax element when the parameter identifier (prmId) syntax element is not less than the sequence parameter set neural network loop filter hop maximum number of parameters (sps_nnlf_hop_max_num_prms) syntax element.

Optionally, in any of the preceding aspects, another implementation of the aspect provides setting the slice neural network loop filter hop scale red difference chroma (slice_nnlf_hop_scale_cr) syntax element equal to the parameter identifier (prmId) syntax element when the parameter identifier (prmId) syntax element is not less than the sequence parameter set neural network loop filter hop maximum number of parameters (sps_nnlf_hop_max_num_prms) syntax element.

Optionally, in any of the preceding aspects, another implementation of the aspect provides that one or more of the slice neural network loop filter hop mode plus one (slice_nnlf_hop_mode_plus1) syntax element, the slice neural network loop filter hop scale flag plus one (slice_nnlf_hop_scale_flag_plus1) syntax element, the slice neural network loop filter hop scale luminance (slice_nnlf_hop_scale_y) syntax element, the slice neural network loop filter hop scale blue difference chroma (slice_nnlf_hop_scale_cb) syntax element, and the slice neural network loop filter hop scale red difference chroma (slice_nnlf_hop_scale_cr) syntax element are coded as an unsigned integer Exp-Golomb-coded syntax element.

Optionally, in any of the preceding aspects, another implementation of the aspect provides that the conversion includes encoding the media data into the bitstream.

Optionally, in any of the preceding aspects, another implementation of the aspect provides that the conversion includes decoding the media data from the bitstream.

A second aspect relates to an apparatus for processing video or image data comprising: a processor; and a non-transitory memory with instructions thereon, wherein the instructions upon execution by the processor, cause the processor to perform any of the disclosed methods.

A third aspect relates to a non-transitory computer readable medium comprising a computer program product for use by a video coding device, the computer program product comprising computer executable instructions stored on the non-transitory computer readable medium such that when executed by a processor cause the video coding device to perform any of the disclosed methods.

A fourth aspect relates to a non-transitory computer-readable recording medium storing a bitstream of a video which is generated by a method performed by a video processing apparatus, wherein the method comprises: determining to use only a slice-level filtering mode to indicate whether a block-level parameter selection is used; and performing a conversion between visual media data and a bitstream based on the slice-level filtering mode.

A fifth aspect relates to a method for storing a bitstream of a video, comprising: determining to use only a slice-level filtering mode to indicate whether a block-level parameter selection is used; generating the bitstream with the slice-level filtering mode; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 shows an example of raster-scan slice partitioning of a picture

FIG. 2 shows an example of a rectangular slice partitioning of a picture.

FIG. 3 shows an example of a picture partitioned into tiles, bricks, and rectangular slices.

FIG. 4A shows an example of coding tree blocks (CTBs) crossing the bottom picture border.

FIG. 4B shows an example of CTBs crossing the right picture border.

FIG. 4C shows an example of CTBs crossing the right bottom picture border.

FIG. 5 shows an example of encoder block diagram.

FIG. 6 illustrates an example of pre-processing and post-processing units.

FIG. 7 illustrates an example architecture of the convolutional neural network (CNN) in filter set 0.

FIG. 8 illustrates an example implementation of the CNN in filter set 0.

FIG. 9 illustrates an example encoder optimization.

FIG. 10A illustrates an example head of luma network.

FIG. 10B illustrates an example subnetwork.

FIG. 10C illustrates another example subnetwork.

FIG. 11 illustrates an example temporal in-loop filter.

FIG. 12A illustrates an example parameter selection at an encoder side.

FIG. 12B illustrates an example parameter selection at a decoder side.

FIG. 13 illustrates prediction of a current block from a context of reference samples around the current block via the neural network-based intra prediction mode.

FIG. 14 illustrates decomposition of a context of reference samples surrounding the current block into the available reference samples and the unavailable reference samples.

FIG. 15 illustrates intra prediction mode signaling for the current luma coding block (CB) framed in the dashed line.

FIG. 16 illustrates an example architecture of high operation point (HOP) model.

FIG. 17 illustrates an example architecture of a low complexity CNN filter set including CANDECOMP/PARAFAC (CP) decomposition and fusion of 1×1 convolutional layers.

FIG. 18 illustrates an example parallel fusion of outputs of the neural network loop filter (NNLF) and Deblocking Filter.

FIG. 19 is a block diagram showing an example video processing system.

FIG. 20 is a block diagram of an example video processing apparatus.

FIG. 21 is a flowchart for an example method of video processing.

FIG. 22 is a block diagram that illustrates an example video coding system.

FIG. 23 is a block diagram that illustrates an example encoder.

FIG. 24 is a block diagram that illustrates an example decoder.

FIG. 25 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and techniques illustrated below, including the exemplary designs and implementations illustrated and described herein, but may be modified within the scope of the appended claims along with their full scope of equivalents.

### 1. Initial Discussion

The present disclosure is related to video coding technologies. Specifically, it is related to the loop filter in image/video coding. The examples may be applied to video coding standard like High-Efficiency Video Coding (HEVC), Versatile Video Coding (VVC), or the standard to be finalized (e.g., third generation audio video standard (AVS3)). The examples may be also applicable to further video coding standards or video codec or be used as post-processing method which is outside of the encoding/decoding process.

### 2. Further Discussion

Video coding standards have evolved primarily through the development of the well-known International Telecommunication Union-Telecommunication Standardization Sector (ITU-T) and International Organization for Standardization (ISO)/International Electrotechnical Commission (IEC) standards. The ITU-T produced H.261 and H.263, ISO/IEC produced Moving Picture Experts Group (MPEG)-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by Video Coding Experts Group (VCEG) and MPEG jointly in 2015. Since then, many new methods have been adopted by JVET and put into the reference software named Joint Exploration Model (JEM). The Joint Video Expert Team (JVET) between VCEG (Q6/16) and ISO/IEC JTC1 SC29/WG11 (MPEG) was created to work on the VVC standard targeting at 50% bitrate reduction compared to HEVC.

The Versatile Video Coding (Draft 10) could be found at: http://phenix.it-sudparis.eu/jvet/doc_end_user/current_document.php?id=10399. The reference software of VVC, named Video Test Model (VTM), could be found at: https://vcgit.hhi.fraunhofer.de/jvet/VVCSoftware_VTM/−/tags/VTM-10.0.

The Joint Video Exploration Team (JVET) of ITU-T VCEG and ISO/IEC MPEG is exploring potential neural network video coding technology beyond the capabilities of VVC. The exploration activities are known as neural network-based video coding (NNVC). The neural network-based (NN-based) coding tools are to enhance or replace conventional modules in the existing VVC design. The implementation of NN-based tools in NNVC 6 are based on Small Ad-hoc Deep Learning (SADL) library. The latest version of NNVC algorithm description draft could be found at: https://jvet-experts.org/doc_end_user/current_document.php?id=13274.

The NNVC-6.0 reference software is provided to demonstrate a reference implementation of encoding techniques and the decoding process, as well as the training methods for neural network-based video coding explored in JVET. The reference software can be accessed via https://vcgit.hhi.fraunhofer.de/jvet-ahg-nnvc/VVCSoftware_VTM.

### 2.1 Definitions of Video Units

A picture is divided into one or more tile rows and one or more tile columns. A tile is a sequence of coding tree units (CTUs) that covers a rectangular region of a picture. A tile is divided into one or more bricks, each of which comprises a number of CTU rows within the tile.

A tile that is not partitioned into multiple bricks is also referred to as a brick. However, a brick that is a true subset of a tile is not referred to as a tile. A slice either contains a number of tiles of a picture or a number of bricks of a tile. Two modes of slices are supported, namely the raster-scan slice mode and the rectangular slice mode. In the raster-scan slice mode, a slice contains a sequence of tiles in a tile raster scan of a picture. In the rectangular slice mode, a slice contains a number of bricks of a picture that collectively form a rectangular region of the picture. The bricks within a rectangular slice are in the order of brick raster scan of the slice.

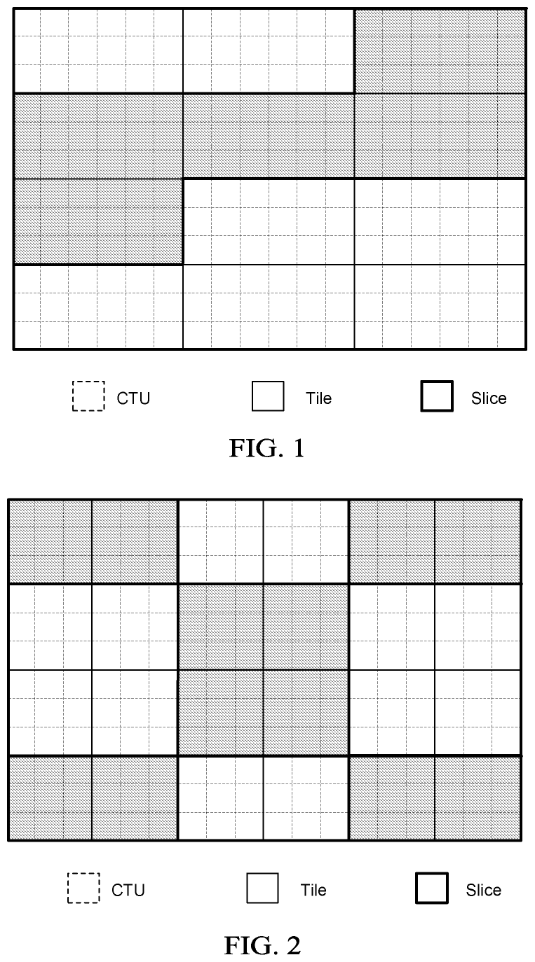

FIG. 1 shows an example of raster-scan slice partitioning of a picture, where the picture is divided into 12 tiles and 3 raster-scan slices. Specifically, FIG. 1 shows a picture with 18 by 12 luma CTUs that is partitioned into 12 tiles and 3 raster-scan slices.

FIG. 2 shows an example of a rectangular slice partitioning of a picture, where the picture is divided into 24 tiles (6 tile columns and 4 tile rows) and 9 rectangular slices. Specifically, FIG. 2 shows a picture with 18 by 12 luma CTUs that is partitioned into 24 tiles and 9 rectangular slices.

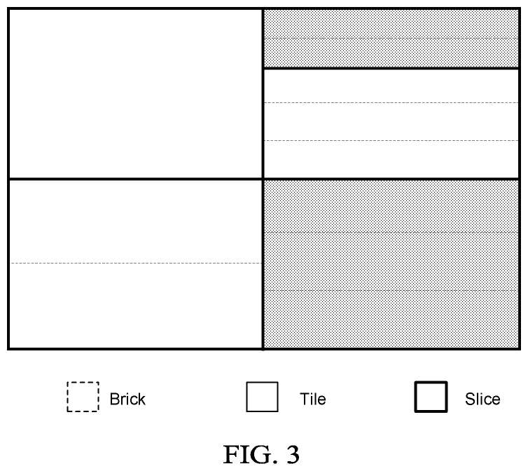

FIG. 3 shows an example of a picture partitioned into tiles, bricks, and rectangular slices, where the picture is divided into 4 tiles (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. Specifically, FIG. 3 shows a picture that is partitioned into 4 tiles, 11 bricks, and 4 rectangular slices.

### 2.1.1 CTU/CTB Sizes

In VVC, the CTU size, signaled in a sequence parameter set (SPS) by the syntax element log 2_ctu_size_minus2, could be as small as 4×4.

### 2.1.2 CTUs in a Picture

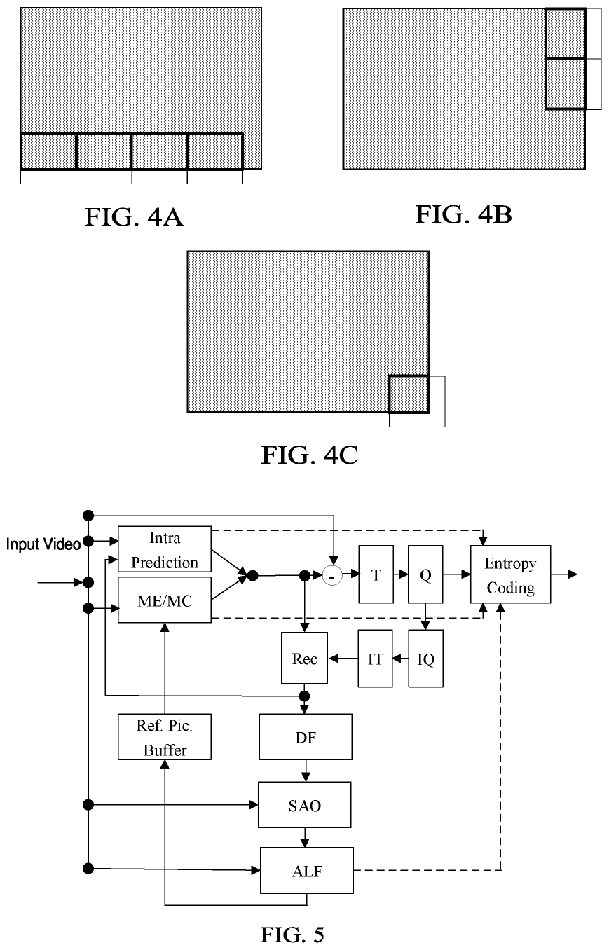

Suppose the CTB/largest coding unit (LCU) size indicated by M×N (typically M is equal to N, as defined in HEVC/VVC), and for a CTB located at picture (or tile or slice or other kinds of types, picture border is taken as an example) border, K×L samples are within picture border wherein either K<M or L<N. For those CTBs as depicted in FIGS. 4A-4C, the CTB size is still equal to M×N, however, the bottom boundary/right boundary of the CTB is outside the picture.

FIG. 4A shows an example of CTBs crossing the bottom picture border. FIG. 4B shows an example of CTBs crossing the right picture border. FIG. 4C shows an example of CTBs crossing the right bottom picture border. Accordingly, FIGS. 4A-4C show examples of CTBs crossing picture borders, where FIG. 4A K=M, L<N; FIG. 4B K<M, L=N; FIG. 4C K<M, L<N.

### 2.2 Coding Flow of a Typical Video Codec

FIG. 5 shows an example of encoder block diagram of VVC, which contains three in-loop filtering blocks: deblocking filter (DF), sample adaptive offset (SAO), and adaptive loop filter (ALF). Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 2.3 Neural Network-Based Video Coding (NNVC)

### 2.3.1 Neural Network-Based Loop Filter Set 0

### 2.3.1.1 Pre-Processing and Post-Processing of Chroma

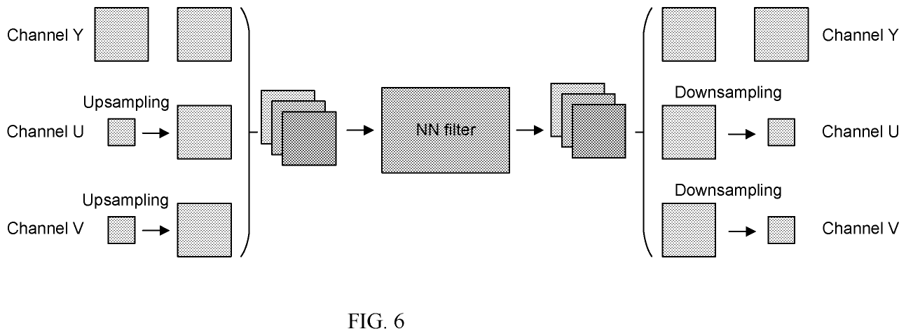

FIG. 6 illustrates an example of pre-processing and post-processing units. In filter set 0, the filter with a single model is designed to process three components. Since the resolutions of luma and chroma are different, pre-processing and post-processing steps are introduced to up-sample and down-sample chroma components respectively as shown in FIG. 6. In the resampling process, the nearest-neighbor interpolation method is used.

### 2.3.1.2 Neural Network

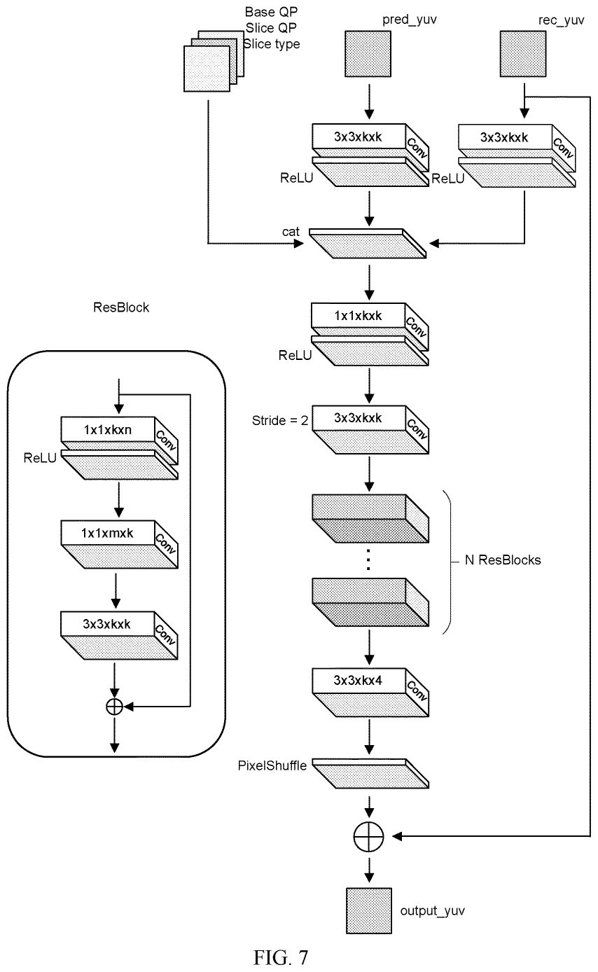

FIG. 7 illustrates an example architecture of the CNN in filter set 0. The network structure of the CNN filter is shown in FIG. 7. Along with the reconstructed image (rec_yuv), additional side information is also fed into the network, such as the prediction image (pred_yuv), slice quantization parameter (QP), base QP and slice type. In the ResBlock, the number of channels firstly goes up before the activation layer, and then goes down after the activation layer. Specifically, K and M are set to 64 and 160 respectively, and the number of ResBlock is set to 32.

2.3.1.3. Combination with Conventional Filters

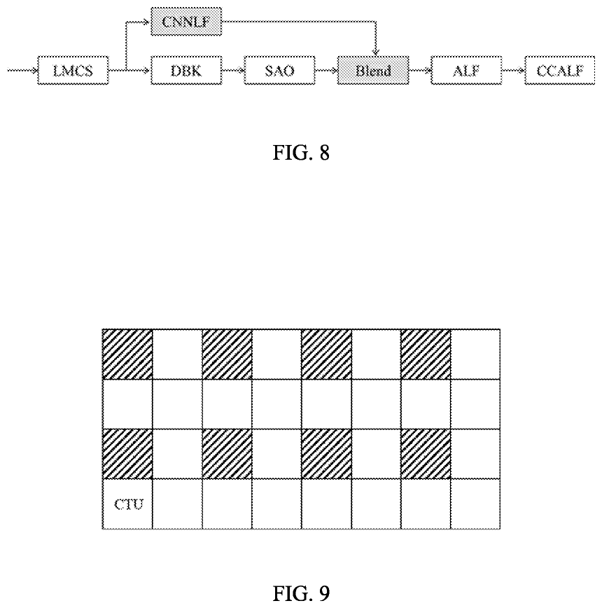

FIG. 8 illustrates an example implementation of the CNN in filter set 0. As shown in FIG. 3, the reconstructed samples before deblocking filter (DBK) are fed into the CNN based filter (CNNLF), then final filtered samples are generated by blending the result of CNNLF and SAO. This blending process can be briefly formulated as:

$${R}_{B l e n d} = w \times {R}_{NN} + ( 1 - w ) \times {R}_{S A O}$$

There are four candidates, 1, 0.75, 0.5 and an adaptive weight, for the blending weight. With regard to the adaptive weight, its derivation is based on least square method. If the adaptive weight is selected, the blending weight is signaled for each color component in the slice header.

### 2.3.1.4. Mode Selection

The CNN filter can be turned on/off at the CTU level and slice level. For each enabling type, there are four blending ways. Therefore, there are nine modes to be evaluated by rate distortion optimization (RDO) at the encoder. The final selected mode would be signaled in the slice header.

TABLE 1
Parameter selection of filter set 0

| Mode | On/off type | Blending weight (w) |
|---|---|---|
| 0 | Disable at slice level | None |
| 1 | Enable at slice level | Adaptive weight |
| 2 | | 1 |
| 3 | | 0.75 |
| 4 | | 0.5 |
| 5 | Enable at CTU level | Adaptive weight |
| 6 | | 1 |
| 7 | | 0.75 |
| 8 | | 0.5 |

### 2.3.1.5 Base QP Adjustment

Base QP is fed into the CNN filter as shown in FIG. 8. To improve adaptation, an offset can be added to the base QP (the adjusted base QP is used as the input to the NN filter) at slice level. The offset candidates are {−5, 5}. For example given the offset −5, the actual input base QP to the filter becomes (BaseQP−5) for the current slice.

### Encoder Approach

FIG. 9 illustrates an example encoder optimization. An example encoder only filters one out of every four CTUs during the process of selecting the best base QP offset to save encoding time. As shown in FIG. 9, only shaded CTUs are considered for calculating distortions of using different BaseQP candidates {BaseQP, BaseQP−5, BaseQP+5}. After the candidate with the smallest cost is selected, the encoder filters the rest of CTUs (non-shaded ones in FIG. 9) by applying the best offset to the base QP. 2.3.1.6. Encoder-Only Optimization

To more accurately estimate the rate-distortion (RD) cost with integrated NN-based in-loop filters, an encoder-only NN filter is involved in the partitioning decision process. In the partitioning mode decision, the distortion between NN filtered samples and original samples is calculated, and then the optimal partitioning mode is selected based on calculated distortion to make the partitioning decision more accurate. To reduce complexity, only few ResBlocks are used in the network structure. The NN filter in the RDO process is implemented with SADL using int16 precision. This encoder-only NN tool is disabled by default.

### 2.3.1.7 Inference Details

SADL (see Section 2.3.4) is used for performing the inference of the CNN filters. Both floating point-based and fixed point-based implementations are supported. In the fixed-point implementation, both weights and feature maps are represented with int16 precision using a static quantization method. The network information in the inference stage is provided in Table 2.

TABLE 2
Network Information of filter set 0 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Number of Parameters (Each Model) | 1.9M |
| | Total Parameter Number | 1.9M, one model in total |
| | Parameter Precision (Bits) | float: 32 |
| | | int: 16 |
| | Memory Parameter (MB) | float: 7.6 MB, one model in total |
| | | int: 3.8 MB, one model in total |
| | Multiply Accumulate (kMAC/pixel) | 485 (assuming frame-level input) |
| | | 615 (assuming block-level input) |
| Optional | Total Conv. Layers | 101 |
| | Total FC Layers | 0 |
| | Total Memory (MB) | |
| | Batch size: | 1 |
| | Patch size | 144 × 144 |
| | Changes to network configuration or weights | |
| | required to generate rate points | |
| | Peak Memory Usage | |
| | Other information: | |

### 2.3.2. Neural Network-Based Loop Filter Set 1

### 2.3.2.1. Neural Network for Luma Component

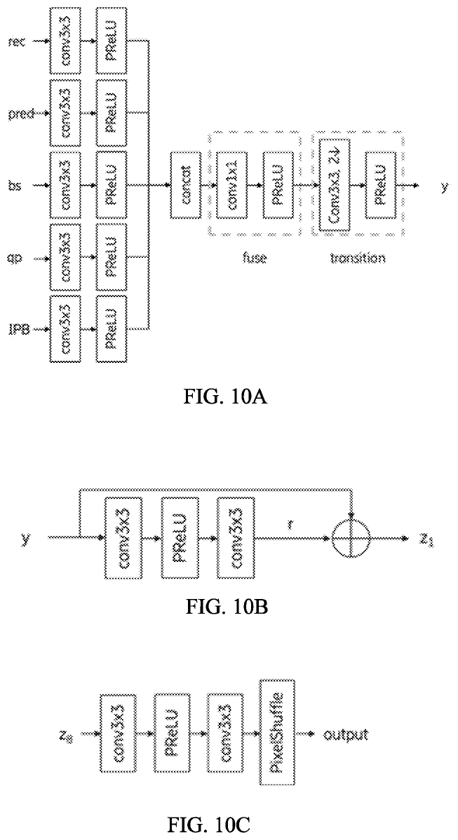

FIGS. 10A-10C illustrate an example architecture of the CNN in filter set 1. FIG. 10A illustrates an example head of luma network. The inputs are combined to form the input y to the next part of the network. FIG. 10B illustrates an example subnetwork. The k-th residual block (k=0 . . . 7). The output y of the head is fed into a first residual block with input z0=y. The output z1 is then fed into another such residual block. FIG. 10C illustrates another example subnetwork. The output of the last residual block is fed into this last part of the network.

There are two regular networks in filter set 1, one for luma and one for chroma. The inputs of the luma network comprise the reconstructed luma samples (rec), the prediction luma samples (pred), boundary strengths (bs), QP, and the block type (IPB). The numbers of feature maps and residual blocks are set as 96 and 8, respectively. The structure of the luma network is depicted in FIG. 10A-10C.

### 2.3.2.23 Neural Network for Chroma Component

Luma information is taken as additional input for the in-loop filtering of chroma. Considering the resolution of luma is higher than chroma in YUV 4:2:0 format, features are first extracted separately from luma and chroma. Then luma features are down-sampled and concatenated with chroma features. The inputs of the chroma network include reconstructed luma samples (recY), reconstructed chroma samples (recUV), predicted chroma samples (predUV), boundary strength (bsUV), and QP. Regarding network backbone, chroma components use the same one as luma.

### 2.3.2.3. Temporal Filter

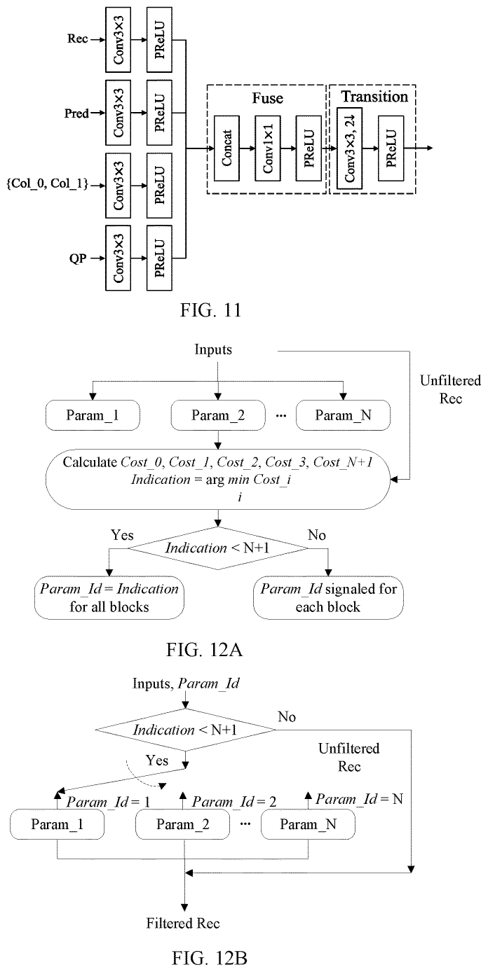

FIG. 11 illustrates an example temporal in-loop filter. Only the head part is illustrated. Other parts remain the same as in FIG. 10B-C. {Col 0, Col 1} refers to collocated samples from the first picture in both reference picture lists. Filter set 1 contains an additional in-loop filter, namely temporal fitter, which takes collocated blocks from the first picture in both reference picture lists to improve performance. The two collocated blocks are directly concatenated and fed into the network as shown in FIG. 11. When enabling temporal filtering feature, the temporal filter is applied to the luma component of pictures in three highest temporal layers, while the regular luma and chroma filters are used for other cases. By default, this temporal filtering feature is disabled.

### 2.3.2.4. Adaptive Inference Granularity

The granularity of the filter determination and the parameter selection is dependent on resolution and QP. Given a higher resolution and a larger QP, the determination and selection are performed in a larger region.

### 2.3.2.5. Parameter Selection

Each slice or block, a determination can be made whether to apply the CNN-based filter or not. When the CNN-based filter is determined to be applied to a slice/block, which conditional parameter from a candidate list including three candidates derived from QP could be further decided. The sequence level QP is denoted as q (inter slice and intra slice use slice QP and sequence QP respectively), and the candidate list includes conditional parameters {Param_1, Param_2, Param_3}. For low temporal layers, Param_1=q, Param_2=q−5. For high temporal layers, Param_1=q, Param_2=q+5. In other words, the second candidate is different across different temporal layers.

FIG. 12A illustrates an example parameter selection at an encoder side. FIG. 12B illustrates an example parameter selection at a decoder side. The selection process is based on the rate-distortion cost at the encoder side. Indication of on/off control as well as the conditional parameter index, if needed, are signalled in the bitstream. FIGS. 12A-12B show the diagram of parameter selection at encoder and decoder sides. All blocks in the current frame need to be processed with three conditional parameters first. Then all costs, i.e. Cost_0, . . . , Cost_N+1, are calculated and compared against each other to achieve optimum rate-distortion performance. In Cost_0, CNN-based filter is prohibited for all blocks. In Cost_i, {i=1, 2, 3, . . . , N}, the parameter Param_i is used for all blocks. In Cost_N+4, different blocks may prefer different parameters, and the information regarding whether to use CNN-based filter or which parameter to be used is signaled for each block. At decoder side, whether to use CNN-based filter or which parameter to be used for a block is based on the Param_Id parsed from the bit-stream as shown in FIG. 12B.

For all-intra configuration, parameter selection is disabled while filter on/off control is still preserved. A shared conditional parameter is used for the two chroma components to ease the burden in worst case at decoder side. In addition, the max number of conditional parameter candidates could be specified at encoder side.

### 2.3.2.6. Residue Scaling

When a NN filter is being applied to reconstructed pictures, a scaling factor is derived and signaled for each color component in the slice header. The derivation is based on least square method. The difference between the input samples and the NN filtered samples (residues) are scaled by the scaling factors before being added to input samples.

2.3.2.7. Combination with Deblocking Filter

To enable a combination with deblocking, the input samples used in the residual scaling is the output of deblocking filtering. The residual scaling process is shown below, where R_{NN} and R_{DB} refer to the outputs of NN filtering and deblocking filtering respectively.

$${R}_{Refine} = ( {R}_{NN} - {R}_{DB} ) \times w + {R}_{DB} = w \times {R}_{NN} + ( 1 - w ) \times {R}_{D B}$$

### 2.3.2.8. Encoder-Only Optimization

Different from NNVC-2.0, EncDbOpt is also enabled for artificial intelligence (AI) configuration. For a better estimation of rate-distortion (RD) cost in the case the NN filter is used, an example encoder introduces NN-based filtering into the rate-distortion optimization (RDO) process of partitioning mode selection. Specifically, a refined distortion is calculated by comparing the NN filtered samples and the original samples. The partitioning mode with the smallest rate-refined distortion cost is selected as the optimal one. To reduce complexity, several fast algorithms are applied. First, NN model is simplified by using a smaller number of residual blocks. Second, parameter selection is not allowed for the NN filtering in the RDO process. Third, the disclosed technique is only applied to the coding units with height and width no larger than 64. The NN filter used in the RDO process is also implemented with SADL using fixed point-based calculation. This NN-based encoder-only method is disabled by default.

### 2.3.2.9. Inference Details

SADL (see section 2.3.4) is used for performing the inference of the CNN filters. Both floating point-based and fixed point-based implementations are supported. In the fixed-point implementation, both weights and feature maps are represented with int16 precision using a static quantization method. The network information in the inference stage is provided in Table 3.

TABLE 3
Network Information of filter set 1 in Inference Stage
Network Information in Inference Stage

| Mandatory | HW environment: | |
|---|---|---|
| | GPU Type | N/A |
| | Framework: | SADL |
| | Number of GPUs per Task | 0 |
| | Total Parameter Number | 1.55M/model, 2 models in total for all |
| | | tests |
| | Parameter Precision (Bits) | float: 32 |
| | | int: 16 |
| | Memory Parameter (MB) | float: 6.2 MB/model, 2 models |
| | | int: 3.1 MB/model, 2 models |
| | Multiply Accumulate (kMAC/pixel) | 532 (assuming frame-level input) |
| | | 673 (assuming block-level input) |
| Optional | Total Conv. Layers | 25 |
| | Total FC Layers | 0 |
| | Total Memory (MB) | |
| | Batch size: | 1 |
| | Patch size | 144 × 144, 272 × 272 |
| | Changes to network configuration or weights | |
| | required to generate rate points | |
| | Peak Memory Usage | |
| | Other information: | |

### 2.3.3. Neural Network-Based Intra Prediction

### 2.3.3.1. Neural Network Inference

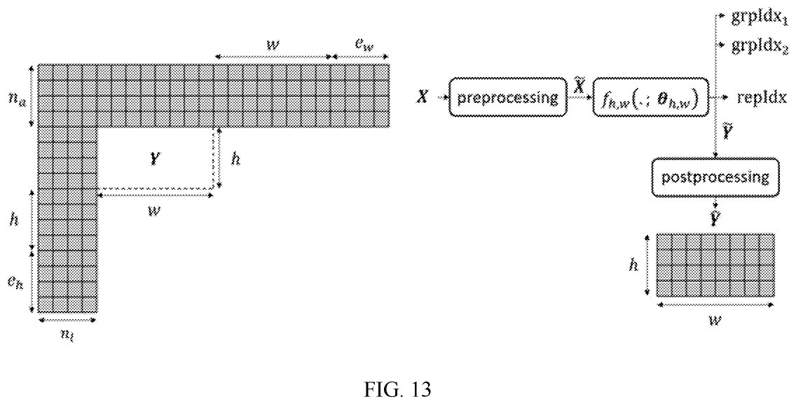

FIG. 13 illustrates prediction of a current w×h block Y from the context X of reference samples around Y via the neural network-based intra prediction mode. Here, w=8 and h=4. The neural network-based intra prediction mode contains 7 neural networks, each predicting blocks of a different size in {4×4, 8×4, 16×4, 32×4, 8×8, 16×8, 16×16}. The neural network predicting blocks of size w×h is denoted f_{h,w}(., θ_{h,w}) where θ_{h,w} gathers its parameters. For a given w×h block Y, f_{h,w}(., θ_{h,w}) takes a preprocessed version X of the context X made of nₐ rows of nₗ+2w+e_{w} reference samples located above this block and nₗ columns of 2h+eₕ reference samples on its left side to provide \tilde{Y}. The application of a postprocessing to \tilde{Y} yields a prediction Ŷ of Y, see FIG. 13. Besides, f_{h,w}(., θ_{h,w}) returns two indices grpIdx₁ and grpIdx₂. grpIdxᵢ denotes the index characterizing the low-frequency non-separable transform (LFNST) kernel index and whether the primary transform coefficients resulting from the application of the discrete cosine transform (DCT)-2 horizontally and the DCT-2 vertically to the residue of the neural network prediction are transposed when lfnstIdx=i, i∈{1,2}, see FIG. 13. Furthermore, f_{h,w}(., θ_{h,w}) gives the index repIdx∈ [symbol] 0, 66 [symbol] of the VVC intra prediction mode (PLANAR or direct current (DC) or directional intra prediction mode) whose prediction of Y from the reference samples surrounding Y best represents Ŷ, see FIG. 13.

```
If min(h, w) ≤ 8 && hw < 256:
  nₐ = nₗ = min(h, w)
otherwise:
  if h > 8:
      nₐ = h/2
  otherwise:
    nₐ = h
  if w > 8:
    nₗ = w/2
  otherwise:
    nₗ = w
If h ≤ 8, eₕ = 4. Otherwise, eₕ = 0.
If w ≤ 8, e_{w} = 4. Otherwise, e_{w} = 0.
```

### 2.3.3.2. Preprocessing and Postprocessing

### 2.3.3.2.1. Preprocessing of the Context of the Current Block

The preprocessing shown in FIG. 13 comprises the four following steps.
The mean μ of the available reference samples X̅ in X, see FIG. 3, is subtracted from X̅.
If the neural network predicting the current block is in floats, the reference samples in the context X are multiplied by ρ=1/(2^{b-8}), b being the internal bitdepth, i.e. 10 in VVC. Otherwise, the reference samples in the context X are multiplied by ρ=2^{Q}^{ᵢₙ}^{-b+8}, Qᵢₙ denoting the input quantizer.
All the unavailable reference samples Xᵤ in X, see FIG. 3, are set to 0.
The context resulting from the previous step is flattened, yielding \tilde{X}, a vector of size

$${n}_{a} ( {n}_{l} + 2 w + {e}_{w} ) + ( 2 h + {e}_{h} ) {n}_{l} .$$

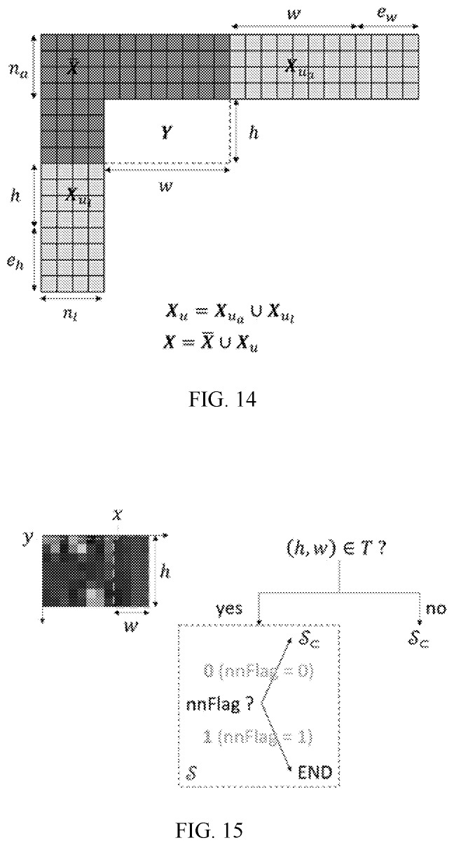

FIG. 14 illustrates decomposition of a context X of reference samples surrounding the current w×h block Y into the available reference samples X̅ and the unavailable reference samples Xᵤ. Here, w=8 and h=4. In the illustrated case, the number of unavailable reference samples reaches its maximum value.

### 2.3.3.2.2. Postprocessing of the Neural Network Prediction

The postprocessing depicted in FIG. 13 comprises reshaping the vector \tilde{Y} of size hw into a rectangle of height h and width w, dividing the result of the reshape by ρ, adding the mean μ of the available reference samples in the context of the current block, and clipping to [0, 2^{b}−1]. Therefore, the postprocessing can be summarized as:

$$\hat{Y} = min ( max ( \frac{reshape ( \tilde{Y} )}{ρ} + μ , 0 ) , {2}^{b} - 1 ) .$$

### 2.3.3.3. Adaptation of the Derivation of the List of MPMs

When creating the most probable mode (MPM) list of a given luma CB, if the “left” luma CB is predicted via the neural network-based intra prediction mode, the neural network-based mode index can be replaced by the repIdx returned during the prediction of the “left” luma CB and become a candidate index to be put into the MPM list. Similarly, if “above” luma CB is predicted via the neural network-based intra prediction mode, the neural network-based mode index can be replaced by the repIdx returned during the prediction of the “above” luma CB and become a candidate index to be inserted into the MPM list.

### 2.3.3.4. Signaling of the Neural Network-Based Intra Prediction Mode

### 2.3.3.4.1. Signaling of the Neural Network-Based Intra Prediction Mode in Luma

FIG. 15 illustrates intra prediction mode signaling for the current w×h luma CB framed in the dashed line. The coordinates of the pixel at the top-left of this CB are (y, x). The bin value of a nnFlag value appears in bold gray. Here, h=8, w=4, x=8, and y=0.

For the current w×h luma CB whose top-left pixel is at position (y, x) in the current luma channel, the intra prediction mode signaling in luma is split into two cases.
If (h,w)∈T, nnFlag appears in the intra prediction mode signaling in luma. nnFlag=1 means that the neural network-based intra prediction mode is selected to predict the current luma CB and END. nnFlag=0 means that the neural network-based intra prediction mode is not selected to predict the current luma CB, then the regular intra prediction mode signaling in luma, denoted S_{⊂}, applies, see FIG. 15.
Otherwise, the regular intra prediction mode signaling in luma S_{⊂} applies.

Note that, in the case “(h, w)∈T && nnFlag=1”, if the context of the current luma CB goes out of the bounds of the current luma channel, i.e. x<nₗ∥y<nₐ, the neural network-based intra prediction is replaced by PLANAR.

$$T = \{ ( 4 , 4 ) , ( 4 , 8 ) , ( 8 , 4 ) , ( 4 , 16 ) , ( 16 , 4 ) , ( 4 , 32 ) , ( 32 , 4 ) , ( 8 , 8 ) , ( 8 , 16 ) , ( 16 , 8 ) , ( 8 , 32 ) , ( 32 , 8 ) , ( 16 , 16 ) , ( 16 , 32 ) , ( 32 , 16 ) , ( 32 , 32 ) , ( 64 , 64 ) \} .$$

### 2.3.3.4.2. Signaling of the Neural Network-Based Intra Prediction Mode in Chroma

For the current w×h chroma CB whose top-left pixel is at position (y, x) in the current chroma channel, the intra prediction mode signaling in chroma is split into two cases.
If the luma CB collocated with this chroma CB is predicted by the neural network-based intra prediction mode:
   If (h, w)∈T, the derived mode (DM) becomes the neural network-based intra prediction mode.
   Otherwise, the DM is set to PLANAR.
Otherwise:
   If (h, w)∈T, nnFlagChroma appears in the intra prediction mode signaling in chroma. nnFlagChroma is placed before the DM flag in the decision tree of the intra prediction mode signaling in chroma. nnFlagChroma=1 means that the neural network-based intra prediction mode is selected to predict the current pair of chroma CBs and END. nnFlagChroma=0 means that the neural network-based intra prediction mode is not selected to predict the current pair of chroma CBs, then the regular intra prediction mode signaling in chroma resumes from the DM flag.
   Otherwise, the regular intra prediction mode signaling in chroma applies.

Note that, in the case where “(h, w)∈T and the DM becomes the neural network-based intra prediction mode” and the case where “(h, w)∈T && nnFlagChroma=1”, if the context of the current chroma CB goes out of the bounds of the current chroma channel, i.e. x<nₗ∥y<nₐ, the neural network-based intra prediction is replaced by PLANAR.

### 2.3.3.5. Transformation of the Context and the Neural Network Prediction

For a given w×h block, if (h, w)∈T, it is possible that the neural network-based intra prediction mode must predict this block but the neural network-based intra prediction mode does not contain f_{h,w} (., θ_{h,w}). In this case, the context of the current block can be down-sampled vertically by a factor δ and/or down-sampled horizontally by a factor γ and/or transposed before the step called “preprocessing” in FIG. 13. Then, the prediction of the current block can be transposed and/or up-sampled vertically by the factor δ and/or up-sampled horizontally by the factor γ after the step called “postprocessing” in FIG. 13. The transposition of the context of the current block and the prediction, δ, and γ are chosen so that a neural network belonging to the neural network-based intra prediction mode is used for prediction, see Table 4.

TABLE 4
decision of transposing the context of the current w × h block
to be predicted and the prediction of this block, the value of γ, and
the value of δ, and the neural network belonging to the neural network-
based intra prediction mode used for prediction for each (h, w) ∈ T.

| height and width of the | | | | neural network used |
|---|---|---|---|---|
| block to be predicted (h, w) | γ | δ | transposition | for prediction |
| (4, 4) | 1 | 1 | no | f_{4, 4}(., θ_{4, 4}) |
| (4, 8) | 1 | 1 | no | f_{4, 8}(., θ_{4, 8}) |
| (8, 4) | 1 | 1 | yes | f_{4, 8}(., θ_{4, 8}) |
| (4, 16) | 1 | 1 | no | f_{4, 16}(., θ_{4, 16}) |
| (16, 4) | 1 | 1 | yes | f_{4, 16}(., θ_{4, 16}) |
| (4, 32) | 1 | 1 | no | f_{4, 32}(., θ_{4, 32}) |
| (32, 4) | 1 | 1 | yes | f_{4, 32}(., θ_{4, 32}) |
| (8, 8) | 1 | 1 | no | f_{8, 8}(., θ_{8, 8}) |
| (8, 16) | 1 | 1 | no | f_{8, 16}(., θ_{8, 16}) |
| (16, 8) | 1 | 1 | yes | f_{8, 16}(., θ_{8, 16}) |
| (8, 32) | 2 | 1 | no | f_{8, 16}(., θ_{8, 16}) |
| (32, 8) | 1 | 2 | yes | f_{8, 16}(., θ_{8, 16}) |
| (16, 16) | 1 | 1 | no | f_{16, 16}(., θ_{16, 16}) |
| (16, 32) | 2 | 1 | no | f_{16, 16}(., θ_{16, 16}) |
| (32, 16) | 1 | 2 | no | f_{16, 16}(., θ_{16, 16}) |
| (32, 32) | 2 | 2 | no | f_{16, 16}(., θ_{16, 16}) |
| (64, 64) | 4 | 4 | no | f_{16, 16}(., θ_{16, 16}) |

### 2.3.4. Small Ad-Hoc Deep Learning (SADL) Library

SADL (Small Ad-hoc Deep-Learning Library) is a header only small library for inference of neural networks. SADL provides both floating-point-based and integer-based inference capabilities. The inference of neural networks in NNVC is based on the SADL.

The table below summarizes the framework characteristics.

TABLE 5
Characteristics of SADL

| | |
|---|---|
| Language | Pure C++, header only. |
| Footprint | ~6000 LOC, library ~300 kB, no dependency |
| Optimization | Some SIMD at hot spots, e.g. convolution (conv2D) and |
| | automatic sparse matrix-vector multiplication |
| Compatibility | Onnx to SADL converter |
| Layer Supports | constants, add, maxPool, matMul (dense and sparse), |
| | reshape, ReLU, conv2D (strided, grouped, separated), |
| | mul, concat, max, leakyReLU, shape, expand, PReLU, |
| | flatten, transpose, Cond2DTranspose, Slicing |
| Type support | float, int32, int16, int8 |
| Quantization | Support adaptive quantizer per layer |
| License | BSD 3-Clause |

NNVC repository uses SADL as a submodule, pointing to the repository here: https://vcgit.hhi.fraunhofer.de/jvet-ahg-nnvc/sadl. Documentation is available in the doc directory of the repository.

### 2.3.5 High Operation Point Model

### 2.3.5.1 Overview

More details of HOP design, training and results can be found in:
HOP design and training choices: JVET-AD0380 “BoG report on NN-filter design unification”
Training progress: JVET-AE0042 “AhG14 & AHG11: Report on AhG teleconference on high operation point (HOP) unified filter training”
HOP training results: JVET-AE0191 “AhG11: EE1-0 High Operation Point model”
HOP training procedure and results: JVET-AE0289 “AhG11: HOP training process and models”
HOP official models for partial training 2: JVET-AE0291 “AhG11: Performance of the NNVC HOP with quantized Stage II model”
HOP full results: JVET-AF0041 AhG11: HOP full results

### 2.3.5.2 Architecture

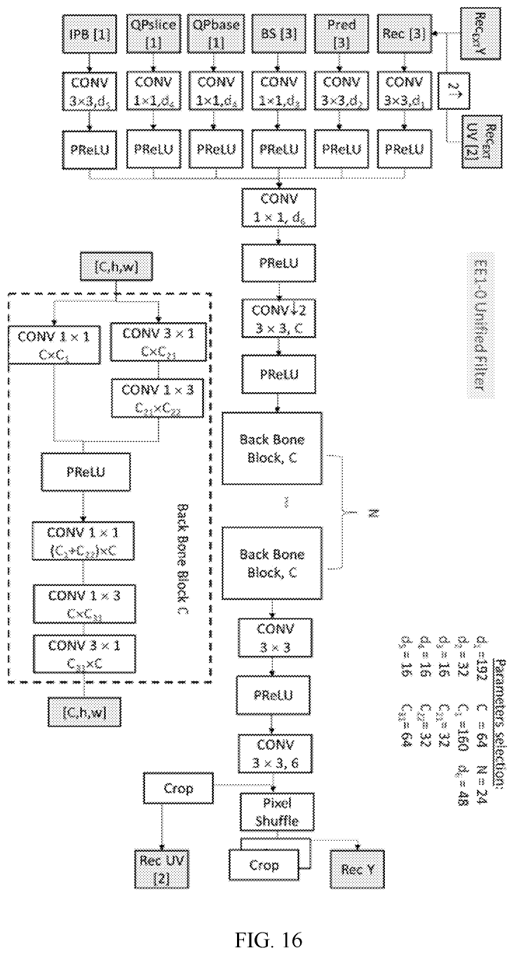

High Operation Point model structure is given by FIG. 16. FIG. 16 illustrates an example architecture of high operation point (HOP) model. The table 6 below gives the characteristics of the model.

TABLE 6
NN Filter network structure aspects

| | Unified high tier filter |
|---|---|
| Joint YUV | ✓ |
| Intra = Inter model | ✓ |
| Prediction | ✓ |
| BS | ✓ |
| QP base | ✓ |
| QP slice | ✓ |
| IPB | ✓ |
| CONV for side Info | ✓ |
| Variable number Channels | ✓ |
| Long Skip connection | ✓ |
| Long/wide Activation | ✓ |
| Number ResBlocks | 24 |
| Conv Decomposed | ✓ |
| multi-scale feature extraction | ✓ |
| Number of channels | ×16 |
| Training Environment | pytorch 1.9 |

### 2.3.5.3 Model Usage Aspects

The table 7 below gives the model application characteristics.

TABLE 7
NN Filter interface aspects

| | Unified |
|---|---|
| | Filter |
| Pre-processing and post-processing of chroma | ✓ |
| Enable DBF/SAO | Both |
| Blending with the DBF/SAO | DBF(*) |
| Slice-level/Block-level blending with adaptive scale factor | ✓ |
| Slice-level/Block-level blending with fixed scale factor | ✓ |
| Separate adaptive scale factor for U and V | ✓ |
| Base QP adjustment | (−5, +5) |
| Encoder-only Optimization | x |
| Temporal filter | x |
| Adaptive inference granularity (128 or 256 block implicit) | ✓ |
| Configurable inference size (64 or 128 block explicit) | ✓ |
| configurable block extension size | ✓ |
| configuration QP params number | ✓ |
| block-level QP adaptation | ✓ |

(*)NNLF comes after De-block but before SAO.

### 2.3.5.4 Inference Details

SADL is used for performing the inference of the HOP model. Both floating point-based and fixed point-based implementations are supported. In the fixed-point implementation, both weights and feature maps are represented with int16 precision using a static quantization method. The network information in the inference stage is provided in the Table. 8.

TABLE 8
Network Information of HOP filter in Inference Stage
Network Information in Inference Stage

| Mandatory | HW environment: | |
|---|---|---|
| | GPU Type | N/A |
| | Framework: | SADL |
| | Number of GPUs per Task | 0 |
| | Total Parameter Number | 1.45M, 1 model |
| | Parameter Precision (Bits) | float: 32 |
| | | int: 16 |
| | Memory Parameter (MB) | float: 5.6 MB |
| | | int: 2.8 MB |
| | Multiply Accumulate (kMAC/pixel) | 477 |
| Optional | Total Conv. Layers | 154 |
| | Total FC Layers | 0 |
| | Batch size: | 1 |
| | Patch size | 144 × 144, 272 × 272 |
| | Changes to network configuration | |
| | or weights required to generate | |
| | rate points | |

### 2.3.6 Low Operation Point Model

### 2.3.6.1 Neural Network

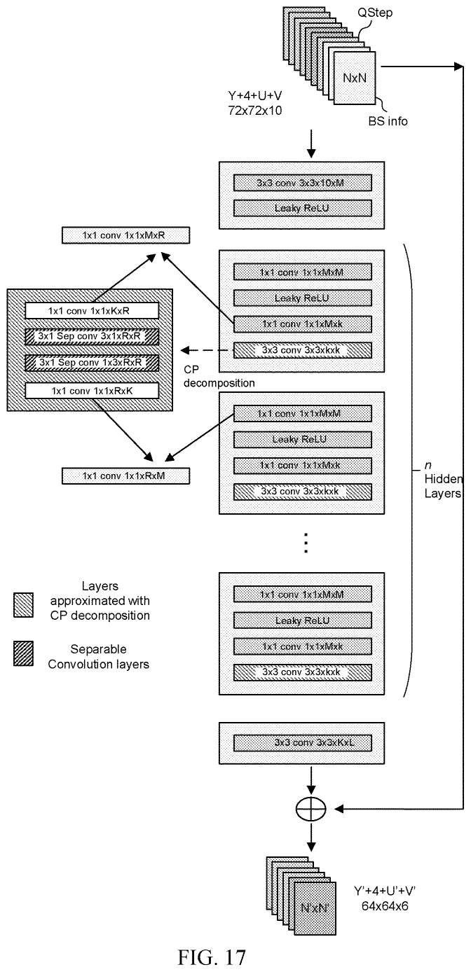

FIG. 17 illustrates an example architecture of a low complexity CNN filter set including CP decomposition and fusion of 1×1 convolutional layers. The network structure of the low complexity operation point CNN based loop filter is shown in FIG. 17. The inputs to the loop filter are reconstructed luma and chroma samples (rec_yuv), boundary strength information for luma and chroma (3 planes) and slice QP plane. Since the resolutions of luma and chroma for YUV420 format are different, the reconstructed luma samples are decomposed into four smaller planes to match the resolution of chroma plane before filtering.

The network comprises a 3×3 CNN input layer which takes in 10 input layers with M (72) output features. This is followed by n (11) hidden layers, each hidden layer consists of 1×1 pointwise convolution with wide activation (M=72), a second 1×1 pointwise convolution with reduced output feature map (K=24) and 3×3 convolution layers which are decomposed and fused into separable layers as follows.

The 3×3 convolutions of each hidden layer are decomposed into 4 layers with rank R followed by fusion of adjacent 1×1 convolution as shown in:
1^{st} layer: 1×1×K×R pointwise convolution
2^{nd} layer: 3×1×R×R separable convolution
3^{rd} layer: 1×3×R×R separable convolution
4^{th} layer: 1×1×R×K pointwise convolution

The final output layer consists of 3×3 convolution layers which outputs filtered samples for L=6 planes (4 luma and 2 chroma planes) used for final residual scaling.

### 2.3.6.2 Residual Scaling

When a NN filter is being applied to reconstructed pictures, a scaling factor is derived and signaled for each color component in the slice header. The derivation is based on least square method. The difference between the input samples and the NN filtered samples (residues) are scaled by the scaling factors before being added to input samples.

2.3.6.3 Combination with Deblocking Filters

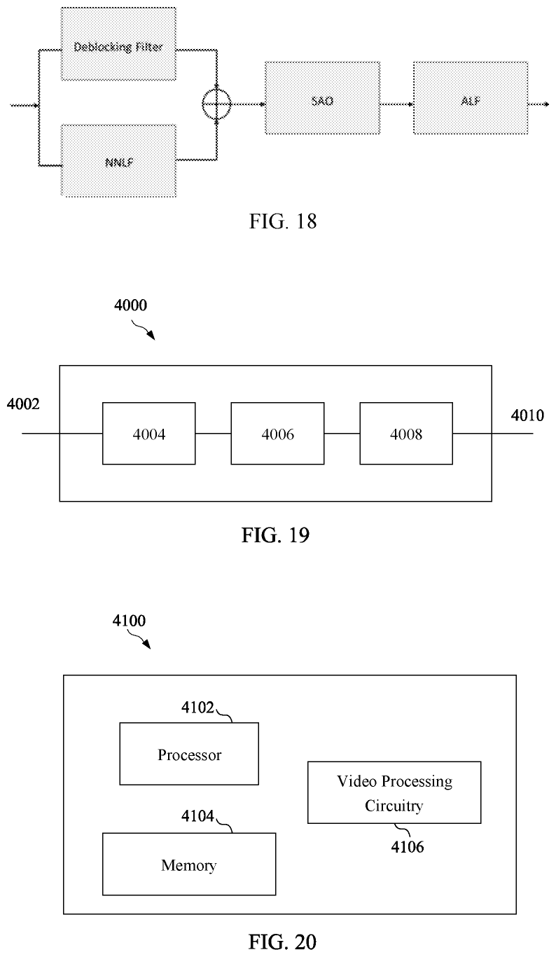

FIG. 18 illustrates an example parallel fusion of outputs of the NNLF and Deblocking Filter. As shown in FIG. 18, the reconstructed samples before Deblocking Filter are fed into the low complexity NN filter (NNLF), then final filtered samples are generated by blending the result of NNLF and Deblocking Filter.

$${R}_{R e f i n e} = w \times {R}_{N N} + ( 1 - w ) \times {R}_{D B}$$

### 2.3.6.4 Inference Details

SADL is used for performing the inference of the CNN filters. Both floating point-based and fixed point-based implementations are supported. In the fixed-point implementation, both weights and feature maps are represented with int16 precision using a dynamic quantization method. The network information in the inference stage is provided in the following table.

TABLE 9
Network Information of low operation
point (LOP) filter in Inference Stage
Network Information in Inference Stage

| Mandatory | HW environment: | |
|---|---|---|
| | GPU Type | N/A |
| | Framework: | SADL |
| | Number of GPUs per Task | 0 |
| | Total Parameter Number | 105132 |
| | Parameter Precision (Bits) | float: 32 |
| | | int: 16 |
| | Memory Parameter (MB) | float: 0.401 MB |
| | | int: 0.201 MB |
| | Multiply Accumulate (kMAC/pixel) | 16.2 |
| Optional | Total Conv. Layers | 46 |
| | Total FC Layers | 0 |
| | Batch size: | 1 |
| | Patch size | 72 × 72 (4 luma and 2 |
| | | chroma planes) |
| | Changes to network configuration | |
| | or weights required to generate | |
| | rate points | |

### 3. Technical Problems Solved by Disclosed Technical Solutions

According to the disclosure, an example HOP filter in NNVC has the following problems.

There is redundancy in signalling the residual scaling flag and slice-level filtering mode. In particular, both the slice-level filtering mode and the residual scaling flag is designed to be able to indicate whether block-level parameter selection is used.

### 4. A Listing of Solutions and Embodiments

The detailed embodiments below should be considered as examples to explain general concepts. These examples should not be interpreted in a narrow way. Furthermore, these embodiments can be combined in any manner.

One or more neural network (NN) filter models are trained as part of an in-loop filtering technology or filtering technology used in a post-processing stage for reducing the distortion incurred during compression. Samples with different characteristics are processed by different NN filter models or a NN filter model with different parameters. This design elaborates how to improve the signalling for NN filter.

It should be noted that the improvement and optimization on the neural network architecture could be also extended to other NN-based coding tools, such as NN-based intra prediction, NN-based cross component prediction, NN-based inter prediction, NN-based super-resolution, NN-based motion compensation, NN-based reference frame generation, NN-based transform design. In the examples below, NN-based filtering technology is used as an example.

In the disclosure, a NN filter can be any kind of NN filter, such as a convolutional neural network (CNN) filter, fully connected neural network filter, transformer-based filter, recurrent neural network-based filter. In the following discussion, a NN filter may also be referred to as a CNN filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple Virtual Pipeline Data Unit (VPDU), a sub-region within a picture/slice/tile/brick. A father video unit represents a unit larger than the video unit. Typically, a father unit contains several video units. E.g., when the video unit is CTU, the father unit could be slice, CTU row, multiple CTUs, etc.
1. To solve problem 1, only slice-level filtering mode is used to indicate whether block-level parameter selection is used and to simplify the signalling of residual scaling flag.
   a. In one example, residual scaling flag could have N+2 states, where N of them are used to indicate using i^{th} (i=1, . . . , N) fixed scaling factor, while the remaining two of them are used to indicate not using residual scaling and using derived scaling factor.
   b. In one example, the residual scaling flag may be binarized with a fixed length code, or a unary code, or a truncated unary code, or an Exponential-Golomb code (e.g., K-th EG code, wherein K=0), or a truncated Exponential-Golomb code.
2. The above solution may be applied to HOP and/or LOP filter.

### 5. Embodiment

Below are some example embodiments for the aspects summarized in section 4. Most relevant parts that have been added or modified are shown in double braces {{ }}, and some of the deleted parts are shown in triple brackets [[[ ]]]. There may be some other changes that are editorial in nature and thus not highlighted.

Example of syntax and semantics related to the high operation point in-loop filter.

### Syntax

Slice header syntax

| | Descriptor |
|---|---|
| slice_header( ) { | |
| ... | |
| if( pps_cu_chroma_qp_offset_list_enabled_flag ) | |
| sh_cu_chroma_qp_offset_enabled_flag | u(1) |
| {{if( sps_nnlf_hop_enabled_flag ) { }} | |
| {{slice_nnlf_hop_mode_plus1 }} | {{ue(v) }} |
| {{if ( slice_nnlf_hop_mode_plus1 != 0 ) { }} | |
| {{slice_nnlf_hop_scale_flag_plus1 }} | {{ue(v) }} |
| {{if ( slice_nnlf_hop_scale_flag_plus1 == 1) { }} | |
| {{if ( slice_nnlf_hop_mode_plus1 < sps_nnlf_hop_max_num_prms + 1) { }} | |
| {{slice_nnlf_hop_scale_y[slice_nnlf_hop_mode_plus1 − 1] }} | {{ue(v) }} |
| {{slice_nnlf_hop_scale_cb[slice_nnlf_hop_mode_plus1 − 1] }} | {{ue(v) }} |
| {{slice_nnlf_hop_scale_cr[slice_nnlf_hop_mode_plus1 − 1] }} | {{ue(v) }} |
| {{ } else { }} | |
| {{for (prmId = 0; prmId < sps_nnlf_hop_max_num_prms; prmId ++ ) { }} | |
| {{slice_nnlf_hop_scale_y[prmId] }} | {{ue(v) }} |
| {{slice_nnlf_hop_scale_cb[prmId] }} | {{ue(v) }} |
| {{slice_nnlf_hop_scale_cr[prmId] }} | {{ue(v) }} |
| {{ } }} | |
| {{ } }} | |
| {{ } }} | |
| {{ } }} | |
| {{ } }} | |
| if( sps_sao_enabled_flag && !pps_sao_info_in_ph_flag ) { | |
| sh_sao_luma_used_flag | u(1) |
| if( sps_chroma_format_idc != 0 ) | |
| sh_sao_chroma_used_flag | u(1) |
| } | |
| ... | |
| } | |

### Semantics

sps_nnlf_hop_enabled_flag equal to 1 specifies that HOP filter is enabled for the sequence. sps_nnlf_hop_enabled_flag equal to 0 specifies that HOP filter is disabled for the sequence.

slice_nnlf_hop_mode_plus1 equal to 0 indicates that the HOP filter will not be used for any blocks in the slice. slice_nnlf_hop_mode_plus1 equal to i (i=1, 2, . . . , sps_nnlf_hop_max_num_prms) indicates that the i^{th} NN filter parameter candidate will be used for all blocks in the slice. slice_nnlf_hop_mode_plus1 equal to sps_nnlf_hop_max_num_prms+1 indicates that the parameter candidate of each block is decided by the parameter index of each block.

slice_nnlf_hop_scale_flag_plus1 equal to 0 specifies indicates residual scaling is disabled for the slice. slice_nnlf_hop_scale_flag_plus1 equal to 1 specifies indicates residual scaling is enabled for the slice, and the residual scaling factor will be derived according to slice_nnlf_hop_scale_y, slice_nnlf_hop_scale_cb, and slice_nnlf_hop_scale_cr. slice_nnlf_hop_scale_flag_plus1 equal to i (i=2, 3, . . . ) specifies that (i−1)th fixed scaling factor will be used for all components.

slice_nnlf_hop_scale_y[prmId] specifies the luma scaling factor for the parameter candidate indexed by prmId.

slice_nnlf_hop_scale_cb[prmId] specifies the cb scaling factor for the parameter candidate indexed by prmId.

slice_nnlf_hop_scale_cr[prmId] specifies the cr scaling factor for the parameter candidate indexed by prmId.

FIG. 19 is a block diagram showing an example video processing system 4000 in which various techniques disclosed herein may be implemented. Various implementations may include some or all of the components of the system 4000. The system 4000 may include input 4002 for receiving video content. The video content may be received in a raw or uncompressed format, e.g., 8 or 10 bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as wireless fidelity (Wi-Fi) or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or Displayport, and so on. Examples of storage interfaces include serial advanced technology attachment (SATA), peripheral component interconnect (PCI), integrated drive electronics (IDE) interface, and the like. The techniques described in the present disclosure may be embodied in various electronic devices such as mobile phones, laptops, smartphones or other devices that are capable of performing digital data processing and/or video display.

FIG. 20 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and techniques described herein. The video processing circuitry 4106 may be used to implement, in hardware circuitry, some techniques described in the present disclosure. In some embodiments, the video processing circuitry 4106 may be at least partly included in the processor 4102, e.g., a graphics co-processor.

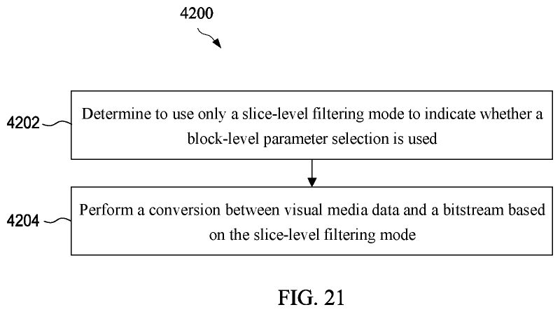

FIG. 21 is a flowchart for an example method 4200 of video processing. The method 4200 determines to use only a slice-level filtering mode to indicate whether a block-level parameter selection is used at step 4202. That is, a residual scaling flag is not used to indicate whether the block-level parameter selection is used. At step 4204, a conversion is performed between a visual media data and a bitstream based on the slice-level filtering mode. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200. Further, a non-transitory computer-readable recording medium may store a bitstream of a video which is generated by the method 4200 as performed by a video processing apparatus. In addition, the method 4200 can be performed by an apparatus for processing video data comprising a processor and a non-transitory memory with instructions thereon. The instructions, upon execution by the processor, cause the processor to perform method 4200.

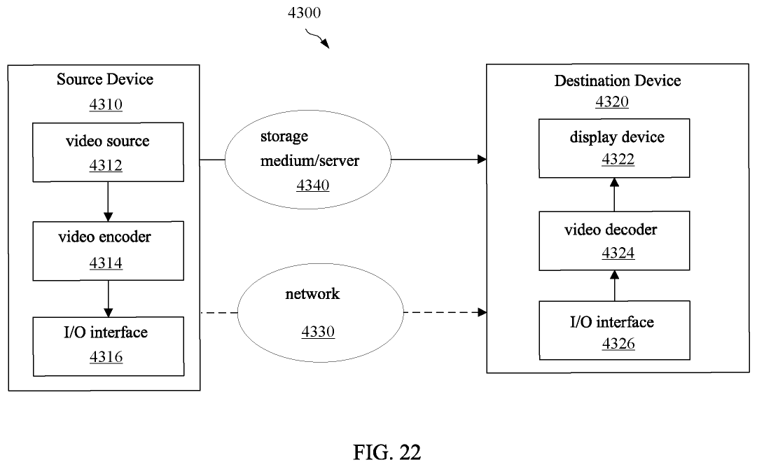

FIG. 22 is a block diagram that illustrates an example video coding system 4300 that may utilize the techniques of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

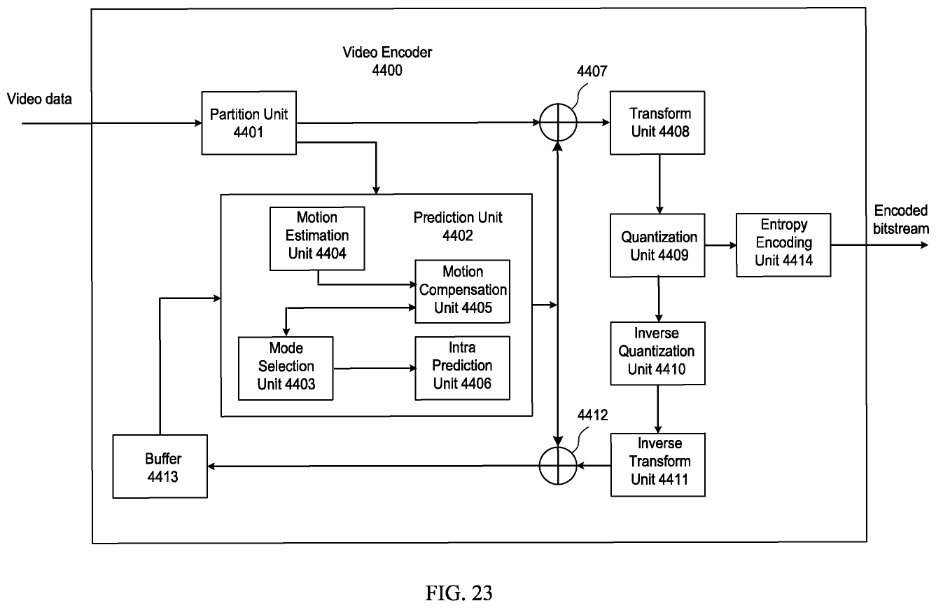

FIG. 23 is a block diagram illustrating an example of video encoder 4400, which may be video encoder 4314 in the system 4300 illustrated in FIG. 22. Video encoder 4400 may be configured to perform any or all of the techniques of this disclosure. The video encoder 4400 includes a plurality of functional components. The techniques described in this disclosure may be shared among the various components of video encoder 4400. In some examples, a processor may be configured to perform any or all of the techniques described in this disclosure.

The functional components of video encoder 4400 may include a partition unit 4401, a prediction unit 4402 which may include a mode select unit 4403, a motion estimation unit 4404, a motion compensation unit 4405, an intra prediction unit 4406, a residual generation unit 4407, a transform processing unit 4408, a quantization unit 4409, an inverse quantization unit 4410, an inverse transform unit 4411, a reconstruction unit 4412, a buffer 4413, and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

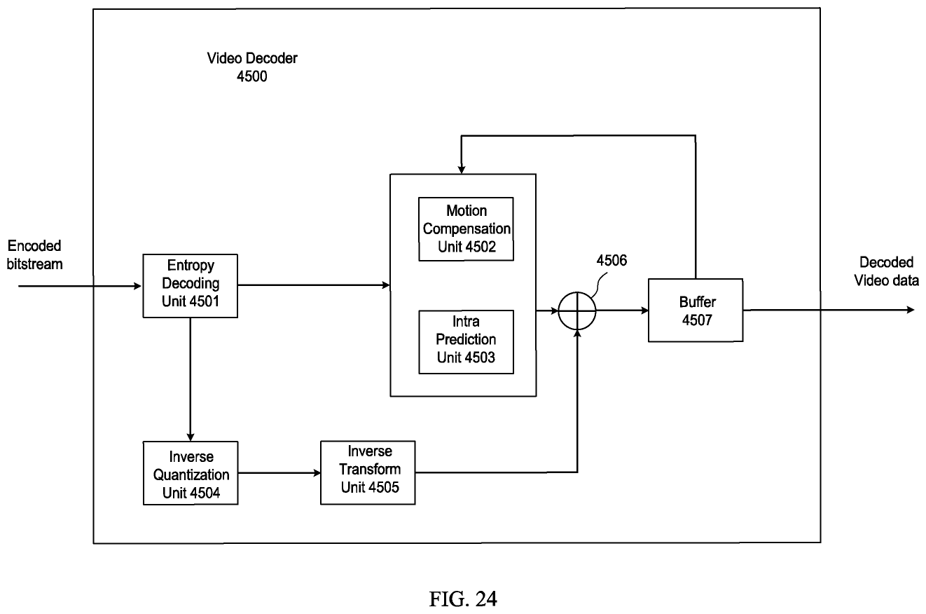

FIG. 24 is a block diagram illustrating an example of video decoder 4500 which may be video decoder 4324 in the system 4300 illustrated in FIG. 22. The video decoder 4500 may be configured to perform any or all of the techniques of this disclosure. In the example shown, the video decoder 4500 includes a plurality of functional components. The techniques described in this disclosure may be shared among the various components of the video decoder 4500. In some examples, a processor may be configured to perform any or all of the techniques described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

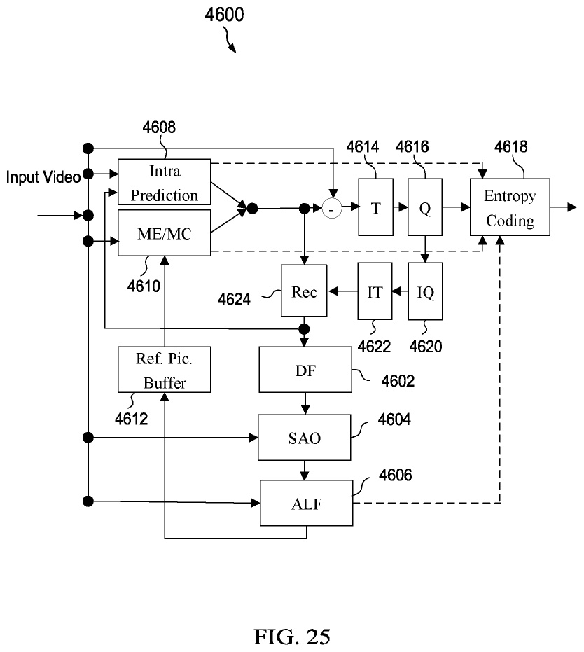

FIG. 25 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of techniques discussed herein.
1. A method for processing video or image data in a neural network comprising: determining to use a slice-level filtering mode to indicate whether a block-level parameter selection is used in order to simplify signalling of a residual scaling flag; and performing a conversion between visual media data and a bitstream based on the residual scaling flag.
2. The method of solution 1, wherein the residual scaling flag has N+2 states, where N of the states are used to indicate using i^{th} (i=1, . . . , N) fixed scaling factor.
3. The method of any of solutions 1-2, wherein a remaining two states are used to indicate not using residual scaling and using a derived scaling factor.
4. The method of any of solutions 1-3, wherein the residual scaling flag is binarized with a fixed length code, a unary code, a truncated unary code, an Exponential-Golomb code, a K-th Exponential-Golomb code where K=0, or a truncated Exponential-Golomb code.
5. The method of any of solutions 1-4, wherein the determining is used to operate a high operation point (HOP) filter.
6. The method of any of solutions 1-5, wherein the determining is used to operate a low operation point (LOP) filter.
7. An apparatus for processing video data comprising: a processor; and a non-transitory memory with instructions thereon, wherein the instructions upon execution by the processor, cause the processor to perform the method of any of solutions 1-6.
8. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-6.
9. A non-transitory computer-readable recording medium storing a bitstream of a video which is generated by a method performed by a video processing apparatus, wherein the method comprises: determining to use a slice-level filtering mode to indicate whether a block-level parameter selection is used in order to simplify signalling of a residual scaling flag; and generating a bitstream based on the determining.
10. A method for storing bitstream of a video comprising: determining to use a slice-level filtering mode to indicate whether a block-level parameter selection is used in order to simplify signalling of a residual scaling flag; generating a bitstream based on the determining; and storing the bitstream in a non-transitory computer-readable recording medium.
11. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field programmable gate array (FPGA) or an application specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of particular techniques. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing video or image data in a neural network, comprising:
determining to use only a slice-level filtering mode to indicate whether a block-level parameter selection is used; and
performing a conversion between visual media data and a bitstream based on the slice-level filtering mode.

2. The method of claim 1, wherein a residual scaling flag is not used to indicate whether the block-level parameter selection is used.

3. The method of claim 2, wherein the residual scaling flag has N+2 states, where N of the states are used to indicate using an i^{th} (i=1, . . . , N) fixed scaling factor, and
wherein a remaining two of the states are used to indicate not using residual scaling and using a derived scaling factor.

4. The method of claim 2, wherein the residual scaling flag is binarized with a fixed length code, a unary code, a truncated unary code, an Exponential-Golomb code, a K-th Exponential-Golomb code where K=0, or a truncated Exponential-Golomb code.

5. The method of claim 1, wherein the conversion is performed by applying at least one of: a high operation point (HOP) filter or a low operation point (LOP) filter.

6. The method of claim 1, wherein a presence of a first syntax element in a slice header of the bitstream is determined based on a value of a second syntax element indicating that a HOP filter is enabled for a sequence, and
wherein a value of the first syntax element equal to zero indicates that the HOP filter is not used for any blocks in a slice.

7. The method of claim 6, wherein the first syntax element is indicated as nnlf_hop_mode_plus1 in the slice header, and the second syntax element is indicated as nnlf_hop_enabled_flag in a sequence parameter set (SPS).

8. The method of claim 6, wherein a presence of a third syntax element in the slice header is determined based on the value of the first syntax element not being equal to zero, and
wherein a value of the third syntax element equal to one indicates that residual scaling is enabled for the slice and a residual scaling factor is derived according to a first set of syntax elements.

9. The method of claim 8, wherein the third syntax element is indicated as nnlf_hop_scale_flag_plus1 in the slice header.

10. The method of claim 8, wherein a presence of the first set of syntax elements in the slice header is determined based on: (i) the value of the third syntax element being equal to one; and (ii) the value of the first syntax element being less than a value of a fourth syntax element plus one,
wherein the first set of syntax elements specifies at least one color scaling factor for a parameter candidate indexed by the value of the first syntax element minus one, and
wherein the fourth syntax element is indicated as nnlf_hop_max_num_prms in a sequence parameter set (SPS).

11. The method of claim 10, wherein the first set of syntax elements comprises:
a fifth syntax element specifying a luma scaling factor for the parameter candidate indexed by the value of the first syntax element minus one,
a sixth syntax element specifying a blue difference chroma (cb) scaling factor for the parameter candidate indexed by the value of the first syntax element minus one, and
a seventh syntax element specifying a red difference chroma (cr) scaling factor for the parameter candidate indexed by the value of the first syntax element minus one.

12. The method of claim 11, wherein the fifth syntax element is indicated as nnlf_hop_scale_y in the slice header and indexed by a value of nnlf_hop_mode_plus1 in the slice header minus one,
the sixth syntax element is indicated as nnlf_hop_scale_cb in the slice header and indexed by the value of nnlf_hop_mode_plus1 in the slice header minus one, and
the seventh syntax element is indicated as nnlf_hop_scale_cr in the slice header and indexed by the value of nnlf_hop_mode_plus1 in the slice header minus one.

13. The method of claim 8, wherein a presence of the first set of syntax elements for each value of a parameter identifier in the slice header is determined based on: (i) the value of the third syntax element being equal to one; and (ii) the value of the first syntax element not being less than a value of a fourth syntax element plus one,
wherein the first set of syntax elements specifies at least one color scaling factor for a parameter candidate indexed by the parameter identifier,
wherein the parameter identifier takes values ranging from 0 to the value of the fourth syntax element minus one, and
wherein the fourth syntax element is indicated as nnlf_hop_max_num_prms in a sequence parameter set (SPS).

14. The method of claim 13, wherein the first set of syntax elements comprises:
a fifth syntax element specifying a luma scaling factor for the parameter candidate indexed by the parameter identifier,
a sixth syntax element specifying a blue difference chroma (cb) scaling factor for the parameter candidate indexed by the parameter identifier, and
a seventh syntax element specifying a red difference chroma (cr) scaling factor for the parameter candidate indexed by the parameter identifier.

15. The method of claim 14, wherein the parameter identifier is a variable, and
wherein the fifth syntax element is indicated as nnlf_hop_scale_y in the slice header and indexed by the parameter identifier,
the sixth syntax element is indicated as nnlf_hop_scale_cb in the slice header and indexed by the parameter identifier, and
the seventh syntax element is indicated as nnlf_hop_scale_cr in the slice header and indexed by the parameter identifier.

16. The method of claim 1, wherein the conversion includes encoding the visual media data into the bitstream.

17. The method of claim 1, wherein the conversion includes decoding the visual media data from the bitstream.

18. An apparatus for processing video or image data, comprising:
a processor; and
a non-transitory memory with instructions thereon, wherein the instructions upon execution by the processor, cause the processor to:
determine to use only a slice-level filtering mode to indicate whether a block-level parameter selection is used; and
perform a conversion between visual media data and a bitstream based on the slice-level filtering mode.

19. The apparatus of claim 18, wherein a residual scaling flag is not used to indicate whether the block-level parameter selection is used,
wherein the residual scaling flag has N+2 states, where N of the states are used to indicate using an i^{th} (i=1, . . . , N) fixed scaling factor, and wherein a remaining two of the states are used to indicate not using residual scaling and using a derived scaling factor,
wherein the residual scaling flag is binarized with a fixed length code, a unary code, a truncated unary code, an Exponential-Golomb code, a K-th Exponential-Golomb code where K=0, or a truncated Exponential-Golomb code, or
wherein the conversion is performed by applying at least one of: a high operation point (HOP) filter or a low operation point (LOP) filter.

20. A non-transitory computer-readable recording medium storing a bitstream of a video which is generated by a method performed by a video processing apparatus, wherein the method comprises:
determining to use only a slice-level filtering mode to indicate whether a block-level parameter selection is used; and
generating the bitstream based on the slice-level filtering mode.
